(19) United States
(12) Patent Application Publication
(10) Pub. No.: US 2009/0313173 A1
(43) Pub. Date: Dec. 17, 2009

(54) Dynamic Negotiation System

(76) Inventors: Inderpal Singh, Buffalo Grove, IL (US); Victoria Husted Medvec, Lake Forest, IL (US)

Correspondence Address: WHITE-WELKER & WELKER, LLC, P.O. BOX 199, CLEAR SPRING, MD, 21722-0199, US

(21) Appl. No.: 12/137,523

(22) Filed: Jun. 11, 2008

(51) Int. Cl. G06Q 10/00

(52) U.S. Cl. 705/80; 705/7

(57) ABSTRACT

The present invention is a software-based dynamic negotiation system that walks an individual or team through a preparation process so they are prepared to enter negotiations. To accomplish this goal, the system solicits feedback from key stakeholders and completes conjoint analysis to understand how team members weigh particular issues and options while also formulating scenarios to test weightings, offers an understanding of possible alternatives, and create equally weighted offers for use in delivering multiple equivalent simultaneous offers. The system provides a framework for effective negotiation that permeates negotiation strategy best practices throughout an organization, as all employees will undertake the same preparation process and utilize similar strategies.

### FEDERALLY SPONSORED RESEARCH

Not Applicable

### SEQUENCE LISTING OR PROGRAM

Not Applicable

### CROSS REFERENCE TO RELATED APPLICATIONS

Not Applicable

### TECHNICAL FIELD OF THE INVENTION

The present invention relates generally to a computer program and method for training purposes. More specifically the present invention relates to a software based negotiation system that: walks an individual or team through the negotiations preparation process, helps them to engage in negotiations, and maintains a “corporate memory” of past negotiations

### BACKGROUND OF THE INVENTION

The present invention was created as a solution to the problems commonly associated with business negotiations and the prior art devices currently available to assist those in preparing for and acting in a negotiation.

In today's global economy, professionals involved in negotiations must increasingly balance multiple stakeholders' varying priorities and issues to achieve their objectives. In most organizations, the overarching priority is to increase profitability. Several methods are known in the prior art that address similar or related issues, but each has shortcomings that the present inventions improves upon or eliminates.

U.S. Pat. No. 6,067,531 issued to Hoyt, et al. for an automated contract negotiator/generation system and method teaches a contract system automates negotiation and generation of contract documents by managing the work flow in a contract approval process. Multiple client users, coupled by a computer network, access a contract database containing multiple contracts with multiple contract components therein. The system manages communications and security between a client system and the contract database. A client applet facilitates client user input at the client system and assists in a standardization of legal phrasing and contract negotiation. The client applet enforces business rules to qualify a contract for expedited approval. Generalized templates are employed to enable rapid prototyping and creation of new contracts. A method governs the automated contract negotiation and generation process within a business organization with assistance from a graphical client user interface.

U.S. Pat. No. 6,338,050 issued to Conklin, et al. for a System and method for providing and updating client user supplied context for a negotiations system a multivariate negotiations engine for international transaction processing which: enables a sponsor to create and administer a community between participants such as buyers and sellers having similar interests; allows a buyer/participant to search and evaluate seller information, propose and negotiate orders and counteroffers that include all desired terms, request sample quantities, and track activity; allows a seller/participant to use remote authoring templates to create a complete Website for immediate integration and activation in the community, to evaluate proposed buyer orders and counteroffers, and to negotiate multiple variables such as prices, terms, conditions etc., iteratively with a buyer. The system provides secure databases, search engines, and other tools for use by the sponsor, which enable the sponsor to define the terms of community participation, establish standards, help promote the visibility of participating companies, monitor activity, collect fees, and promote successes.

U.S. Pat. No. 5,924,082 issued to Silverman, et al. for a negotiated matching system that includes a plurality of remote terminals associated with respective potential counter-parties, a communications network for permitting communication between the remote terminals, and a matching station. Each client user enters trading information and ranking information into his or her remote terminal. The matching station then uses the trading and ranking information from each client user to identify transactions between counter-parties that are mutually acceptable based on the ranking information, thereby matching potential counter-parties to a transaction. Once a match occurs, the potential counter-parties transmit negotiating messages to negotiate some or all terms of the transaction.

U.S. Pat. No. 6,112,189 issued to Rickard, et al. for a method and apparatus for automating negotiations between parties teaches a system that calculates the mutual satisfaction between negotiating parties and maximizes their mutual satisfaction over a range of decision variables and does so without requiring the parties to identify themselves and their positions to each other. For automatically negotiating agreements between multiple parties, a computer accepts a satisfaction function from an offering party who defines his degree of satisfaction to agree to a range of terms upon which the party is desirous of negotiating as a function of the relevant decision variables. The computer then accepts input from all other parties regarding their degree of satisfaction to agree to each of the terms as a function of a particular relevant decision variable. The computer then calculates a satisfaction function for each of these terms based on all of the individual inputs. Next, the computer calculates a joint satisfaction function for all of the terms as a function of the particular relevant decision variable, and then calculates the mutual satisfaction function for the offering party and the other parties, also as a function of the particular relevant decision variable. Finally, the computer calculates the set of decision variable yielding the maximum mutual satisfaction and provides this output to the parties.

What is lacking in the prior art previously described is a system that provides a theory and the tools to implement that philosophy to maximize profitability across an organization by permeating these best practices throughout the organization. The premise of the system is overall increased profitability—thinking about profitability across a range of issues, not solely on price. The present invention focuses on the multiple issues affecting profitability which are key to the system.

Research suggests a number of hurdles complicate negotiations in today's environment such as: Multiple Competing Priorities: where individuals must continuously balance the needs of stakeholders from a variety of business functions and locations; Evaluating Non-Quantifiable Features: where negotiators struggle with prioritizing qualitative factors, causing them to narrowly focus on single issues such as price; Lack of Consistent Process: in most organizations, negotiations do not follow a consistent process, causing outcomes to vary wildly within a single organization; and No Analytical Negotiation Tools: which ensures negotiators are unable to quickly and correctly make tradeoff decisions in the midst of a negotiation. The system of the present invention also has no “corporate memory”—in that it doesn't know which deals have been executed in the past and it can't quickly compare current deals to historical deals, and can't compare deals by splicing them by geography, time frame, etc.

The present invention teaches a comprehensive solution that includes both a software system that helps client users prioritize interests, evaluate deals, and arrive at profitable outcomes, as well as a training program for professionals in negotiations best practices. This integrative program helps formalize the negotiation process across the organization and results in outcomes that are, on average, more profitable for the client user's organization.

Recent research in the field has shown that focusing on many issues and making multiple equivalent offers provides superior results. The present invention applies this research to help permeate these best practices throughout an organization. The integrated approach differentiates the present from existing negotiation training and software system taught in the prior art. Currently expert practitioners primarily focus on deal-by-deal assistance, which is not scalable across an organization. Training companies focus on simply describing best practices with role-play exercises, while related software programs currently available on the market are simple e-Learning tools, communicating best practices via an online format.

The present invention combines expert training with a comprehensive software system that introduces a number of analytical features not previously available in other software tools taught by the prior art.

One shortcoming with prior art systems is that they fail to solicit feedback from key stakeholders or incorporate conjoint analysis to understand how team members truly weigh particular issues and options while also formulating possible scenarios.

Yet another shortcoming known in the prior art is the inability of such system to test weightings and offer an understanding of possible alternatives, and create equally weighted offers for use in delivering multiple equivalent simultaneous offers.

### SUMMARY OF THE INVENTION

In accordance with the present invention a software based dynamic negotiation system is provided which overcomes the aforementioned problems of the prior art. The present invention walks an individual or team through a preparation process so they are prepared to enter negotiations.

The present invention improves over the prior art by forcing an understanding of the issues in play and the relative value of the possible options in a negotiation. To accomplish this goal, the present invention solicits feedback from key stakeholders and optionally completes conjoint analysis to understand how team members truly weigh particular issues and options. The system also formulates scenarios to test weightings, offers an understanding of possible alternatives, and creates equally weighted offers for use in delivering multiple equivalent simultaneous offers (MESOs).

The dynamic negotiation system helps permeate negotiation strategy best practices throughout an organization. The system provides a framework for effective negotiation, as all employees undertake the same preparation process and utilize similar strategies, resulting in superior agreements for negotiations of all sizes and in all areas of the organization. In addition to permeating best practices, the system helps maintain a “corporate memory” of past deals, allowing users to quickly reference past negotiations against each other, as well as compare them to their current negotiation.

There are two parts to the dynamic negotiation system: the client module and the online module. The client module runs locally on a personal computer while the online module provides an online repository that contains files and functionality that can be shared by all online client users within a group or company.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates an overall physical view of the system architecture;

FIG. 2 is a flow chart providing a graphical depiction of the overall process flow for the dynamic negotiation system of the present invention;

FIG. 3 is a flow chart illustrating the process steps of starting a new negotiation;

FIG. 4 is a flow chart illustrating the process of the opposite scoring system;

FIG. 5 is a flow chart illustrating the BATNA process;

FIG. 6 is a flow chart illustrating the Goal Creation process;

FIG. 7 is a screen shot of the search negotiation screen of the present invention;

FIG. 8 is a screen shot of the start new negotiation screen of the present invention;

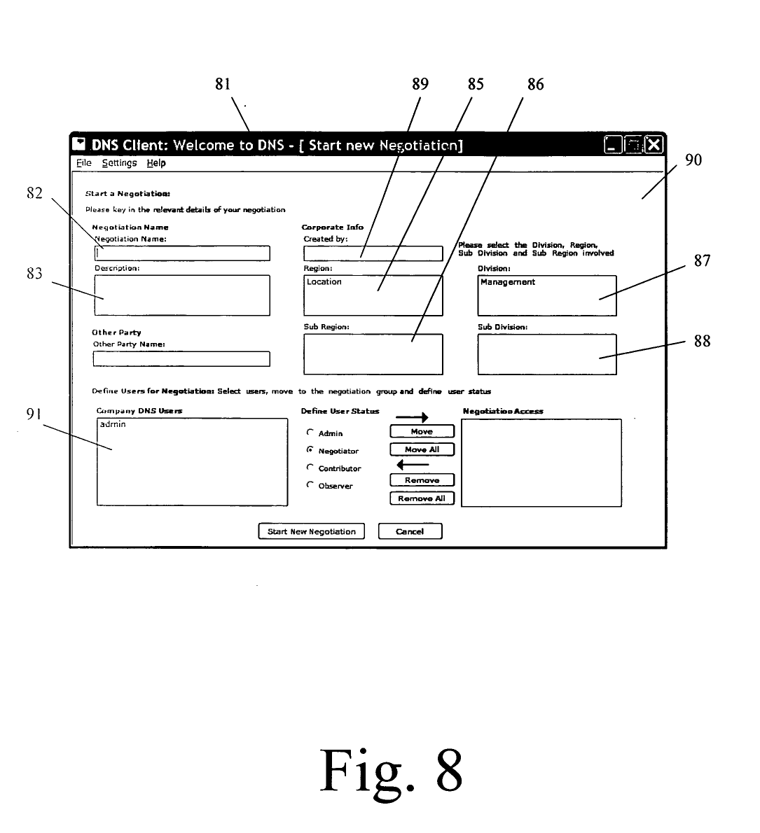

FIG. 9 is a screen shot of the start new negotiation define issues screen of the present invention;

FIG. 10 is a screen shot of the main scoring system screen of the present invention;

FIG. 11 is a screen shot of the BATNA viewing screen of the present invention;

FIG. 12 is a screen shot of the OneView of selected offers screen of the present invention;

FIG. 13 is a screen shot of the MESO at Goal screen of the present invention;

FIG. 14 is a screen shot of the filtered offers screen of the present invention;

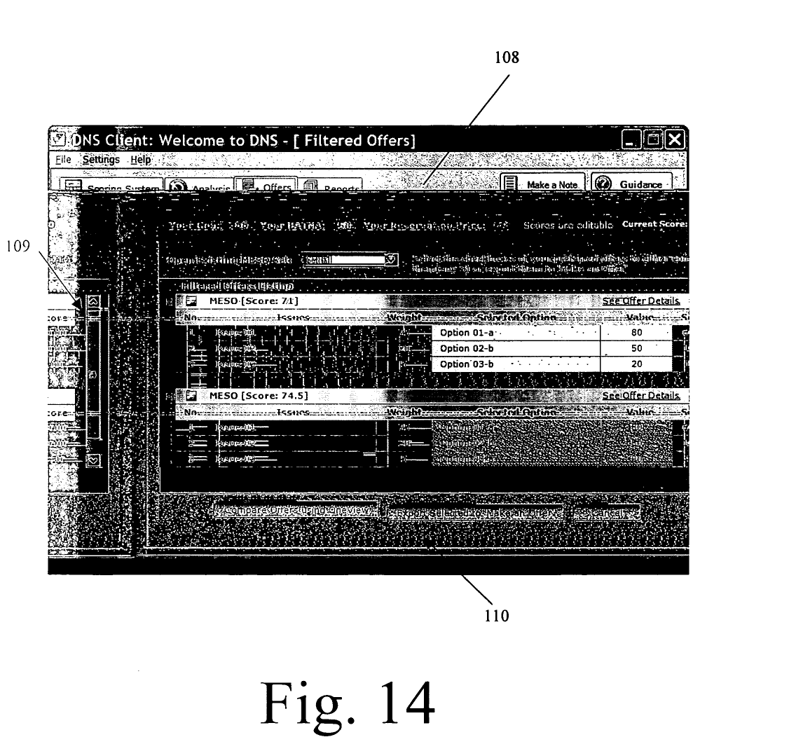

FIG. 15 is a screen shot of the offer entry screen of the present invention;

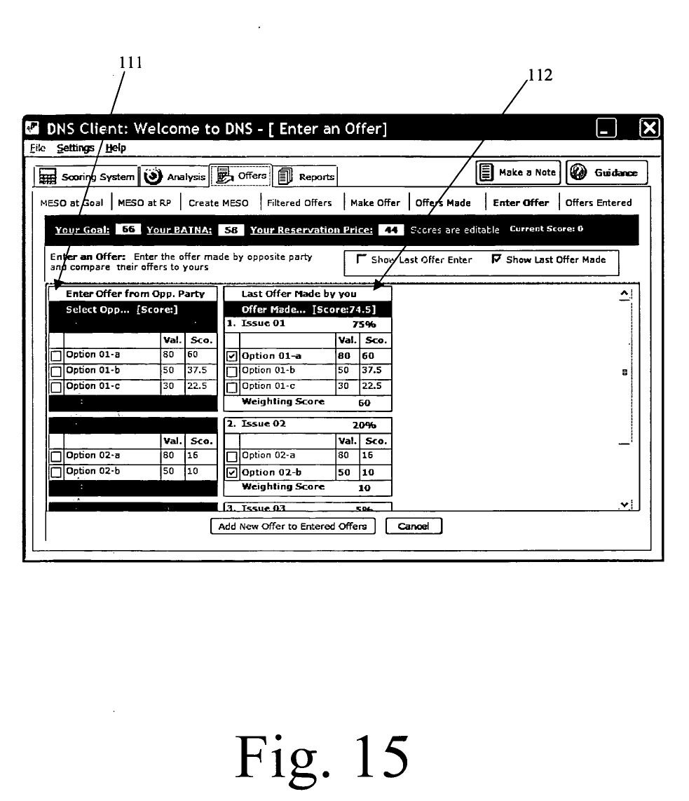

FIG. 16 is screen shot of the MESO report with scoring;

FIG. 17 is screen shot of the Executive Summary Report;

FIG. 18 is screen shot of the Offer History report;

FIG. 19 is screen shot of the Negotiation Notes report;

FIG. 20 is a flow chart illustrating the Conjoin Analysis process from start to send;

FIG. 21 is a flow chart illustrating the process for submitting conjoint feedback;

FIG. 22 is a flow chart illustrating the process for generating a conjoint analysis report; and

FIG. 23 is a flow chart illustrating the process for viewing a conjoint analysis report.

### DEFINITIONS OF IMPORTANT TERMS AND ACRONYMS

DNS is an acronym for “dynamic negotiation system” which is defined as the entire system and negotiation method taught by the present invention.

Issue is defined as a topic/subject of discussion that is of particular interest in a negotiation. Each issue has a range of alternatives or options, one of which must ultimately be agreed upon by the negotiators in order to achieve an agreement, which may be to leave the issue out of the final agreement.

Offer is defined as a combination of options of the various issues (a package) that is presented by one negotiator to the other.

Option is defined as one of the alternative values that an issue can take. For example, the issue “Tolerable product failure rate” may have the options 3%, 5%, and 10%.

Package is defined as a particular combination of options (i.e. price, payment terms, failure rate, etc.) that has been selected across all the issues which becomes an offer when it is presented to the other side.

Post-settlement is defined as the period after the first agreement has been achieved.

Trade-off is defined as an exchange process in which a decision maker gives up one issue or some portion of that issue so as to gain on other issues.

Main Scoring System is defined as a subjective measurement that expresses the relative value of different packages by using a numerical scale. The numerical scale used is arbitrary, typically ranging from 1 to 100. The minimum number expresses the least desirable and least preferred package. The highest number represents the most desirable and most preferred package. There is also the ability to use a dollar value system—where instead of 100 points, the system allows a user to define the dollar value of the deal and everything becomes a percentage of that.

Reservation Price (RP) is defined as the negotiator's bottom line (minimum score). At any value below this, a negotiator would prefer to walk away rather than to accept the deal.

BATNA is an acronym for “Best Alternative To a Negotiated Agreement” which is defined as the best outside alternative to the agreement being negotiated and is generally an agreement with another company, different supplier, or different person. One could use their score from a negotiation with another party as their BATNA for their current negotiation.

Goal is defined as the value a negotiator hopes to achieve in the agreement. This value should be determined across all of the issues rather than on a single issue. This value defines what a negotiator wants to get as opposed to what he or she must get (which is reflected in the reservation price).

MESOs is an acronym for “Multiple Equivalent Simultaneous Offers” which is defined as offers which yield the same total value for the negotiator who is presenting them to the other side.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention. Referring to the figures, it is possible to see the various major elements constituting the apparatus of the present invention.

### Method for Preparing for a Negotiation

The present steps are to be considered before the input of information into the system. A user should first list the issues and rank them accordingly. Next, the user should create a list of options for each issue and rank them accordingly. With the user's issues and options defined, the next step is to define a goal. Next, the user must define his BATNA and use the BATNA to determine a reservation price. Finally, the user must consider the weakness of the other parties involved in the negotiation so that the system can predict the other parties' reactions to proposed options. Not all of these steps are mandatory. In fact, listing the issues and options, and their weights and values, is the only mandatory part of the system.

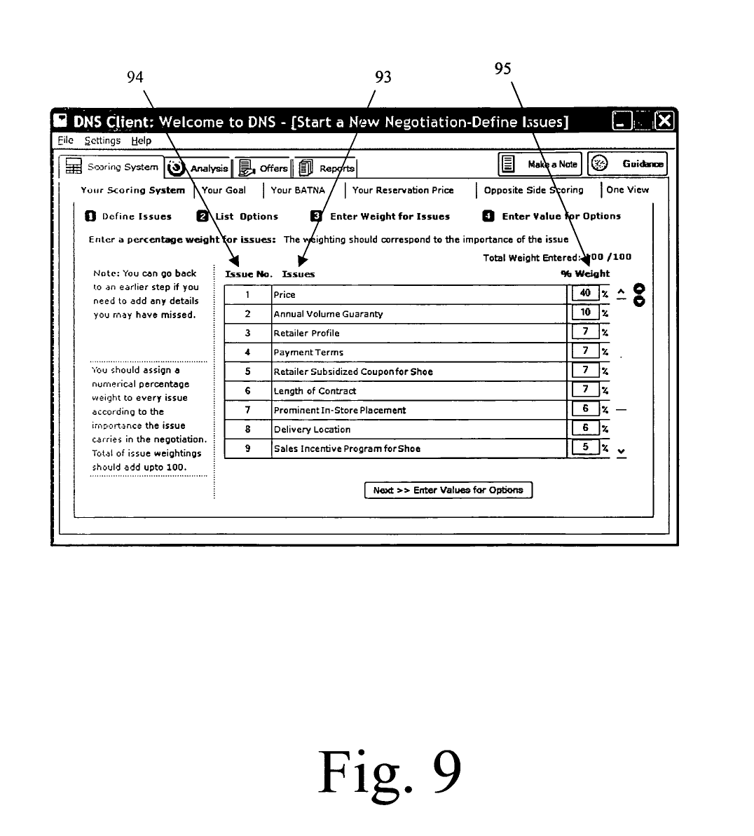

In a first step, the client users should list of all of the issues 93 for the negotiation and rank them from most preferable to least preferable 94 as illustrated in FIG. 9. The client user should strive to have more issues in the negotiation rather than fewer issues, because more issues will allow the client user to uncover more preference differences between the client and the other side. As the client user lists the issues, he should also try to fractionate them into small buckets rather than big buckets. This fractionalization is also known as the Weight for the Issue 95 tab is selected. The client user can assign a weight percentage 95 to each issue 93 according to the importance the issue carries in the negotiation. In a preferred embodiment, the total of the weights must equal 100%, but in alternative embodiments, the system provides setting options to allow a weight total.

For example, the issue of timing can be fractionated into a number of smaller issues such as: when the work is started, what the completion date is, whether the work will be completed in a continuous time period, and how long the work will take to complete. By having these issues in smaller buckets rather than in the one big timing bucket, the client user is more likely to discover differences in the client user's preferences and the other side's preferences.

Also, when the client user lists the issues, he strives to add issues that the other side may raise as well. The client user can also include an issue in the client user scoring system that cannot be negotiated but that the client user values. For example, if the client user were a professional service company, the client user may value having a client with a marquis name. Although the client user cannot negotiate whether the client has this, this is something the client user may want to value in the client user's scoring system.

This is important because one purpose of this scoring system is to allow the client user to compare the client user's current alternative to his best outside alternative (BATNA). If the client user's BATNA does not have a marquis name, the client user may be willing to do the work for a lower rate for the company with the marquis name than for the other option. In essence, the marquis name would contribute to the overall value of the deal.

In a second step, the client user should list options for each issue and rank them. For each issue, options should be listed and ranked from most preferable to least preferable. For example, the issue of when work will begin could have the options of the next day, within one week, within two weeks, within three weeks, or within the month.

In a third, optional, step, the user must define a goal. The client user's goal reflects what the client user wants to receive in the negotiation. This is not what the client user thinks he will get or what he needs to get, but the client user's ideal outcome. Goals are critical in negotiations. People who establish more aggressive goals achieve better outcomes.

In a fourth step, the client user's BATNA must be determined, which reflects what the client user will do if he does not achieve an agreement in the current negotiation. One of the biggest benefits of having a scoring system is that it allows the client user to value his BATNA. This is essential, because the client user's BATNA never mirrors the current deal on the table.

For example, if the client user is negotiating with a client, the client user's BATNA may be another client for whom the client user will work if the client user does not get a deal with the current party. However, the client user cannot simply compare the price the client user would get from the current client to the price the client user could secure from another client, because it may be that the current client is not well known, is only willing to sign a one-year deal, and will pay in 120 days, while the alternative client has a marquis name, is willing to sign a three-year contract, and will pay within 10 days. The BATNA rarely looks exactly the same as the current deal, and the client user cannot compare the two on a single issue. The scoring system allows the client user to evaluate the BATNA across the full range of issues.

In order to value his BATNA, the client user should begin by thinking about his best outside option and what he will do if he does not reach an agreement in the current negotiation. The client user should also remember to include issues that are relevant to his BATNA and not to the current deal.

In a fifth step, the client user must establish a bottom line or minimum condition upon which he will agree with the other party in the negotiation. The client user's reservation price is his bottom line. The client user would prefer an impasse to any outcome below his reservation price. It is critical for the client user to know his reservation price before entering into a negotiation. If the client user does not know his reservation price, he may walk away from a negotiation with an agreement that is worse for him than if he had not entered into an agreement at all.

The client user's reservation price should not be established on a single issue. It is better to define the client user's reservation price across an entire package of issues. Understanding the client user's BATNA will help him establish his reservation price. The client user's reservation price should be equivalent to his BATNA plus or minus any idiosyncratic factors that might make him prefer one alternative to another. Once the client user calculates his BATNA, he should look at the total value of his BATNA and determine the value of his reservation price.

Finally, in a sixth step, the client user must consider the weaknesses of the other parties involved in the negotiation. The client user must choose and weigh issues and issue options that he thinks are important to the other side. The system of the present invention then integrates this information into the negotiation to help the client user predict the other side's reactions.

The first six steps in creating a scoring system are described in detail above. There are four additional steps in validating the scoring system, which are still part of the preparation process, and, in a preferred embodiment, include everything on the analysis tab as illustrated in the figures, indifference tests, obtaining feedback, and obtaining conjoint feedback.

### System Architecture

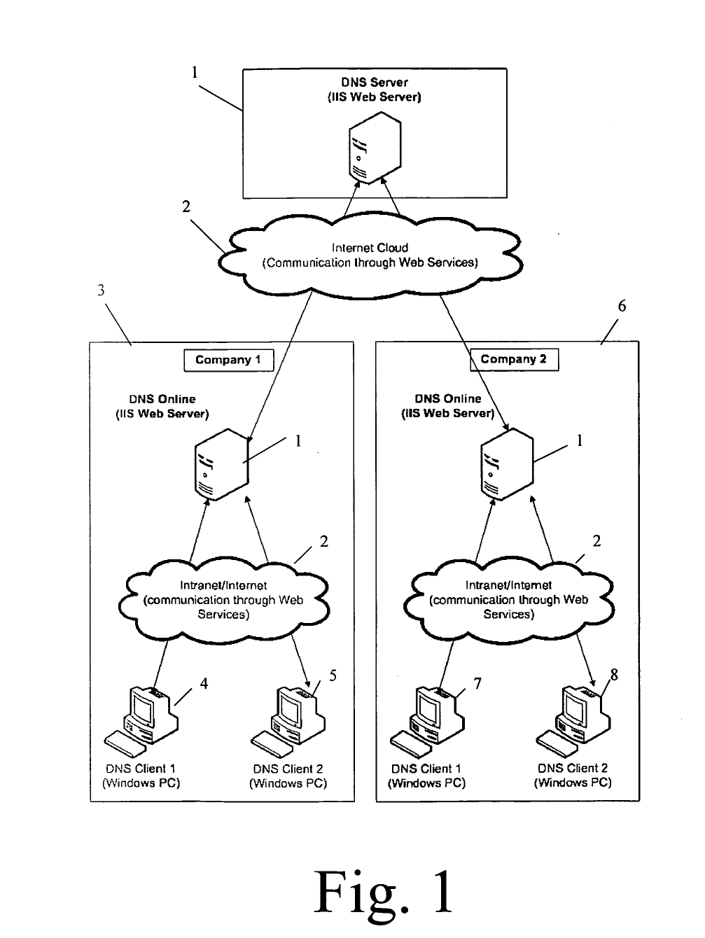

The overall physical system architecture is illustrated in FIG. 1. The physical system is comprised of a central web server 1 that is connected via a multi-client user network 2, such as the Internet, to a plurality of company or client computers or computer network systems. Each company has many DNS clients on a desktop communicating with their online DNS. All of these different companies' online DNS systems communicate with the system of the present inventions' DNS for licensing purposes, as well as automating negotiation between system clients so they can complete deals amongst themselves.

For example, for a first company 3, the central web server 1 is connected via a multi-client user network 2, such as the Internet, to a first client computer 4 and a second client computer 5. With respect to a second company 6, the central web server 1 is connected via a multi-client user network 2, such as the Internet, to a first client computer 7 and a second client computer 8. This physical architecture can be duplicated for any number of companies or clients.

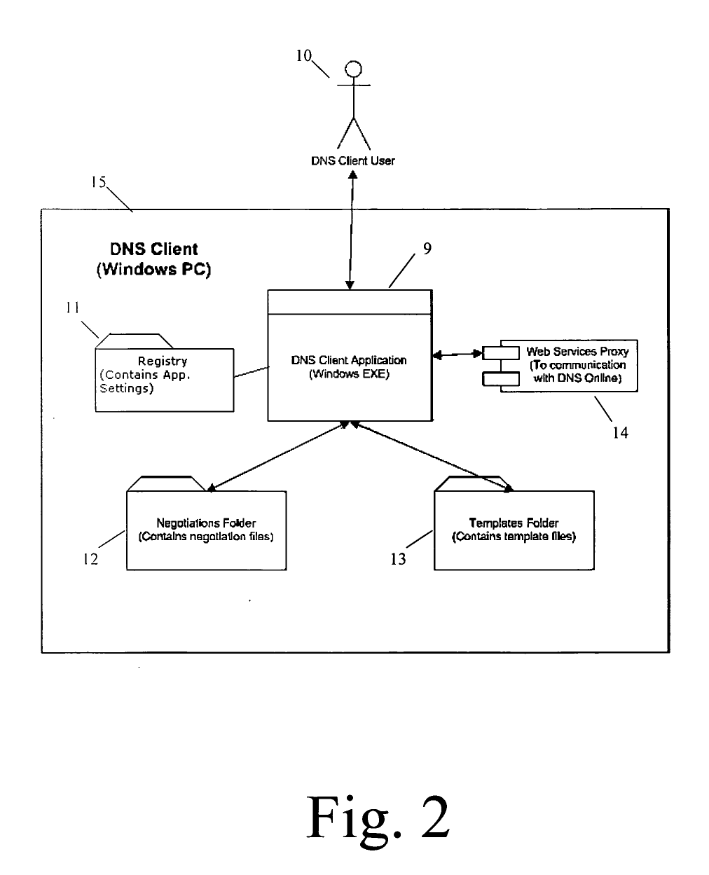

Now referring to FIG. 2, the system of the present invention also utilizes a client application 9 that is loaded on a client computer 15 and is accessed by a client user client 10. The client application 9 is comprised of a registry 11, which contains application settings, a negotiations folder 12 containing negotiation files, a templates folder 13 containing template files, and a web services proxy 14 that enables communication with the online DNS 1.

Upon start up of the client application 9, the first screen a client user client will see is a login page. By default, a login is not required to open and enter the application, but this is dependent on the install-time settings and can be changed. On the login screen, if the client user does not want to be prompted for a client user name and password every time, the “login required” option in the client security can be unselected. After successful login, the client user comes to a workspace, where operations such as Create Negotiation and Open Negotiation Search Template can be selected as discussed below.

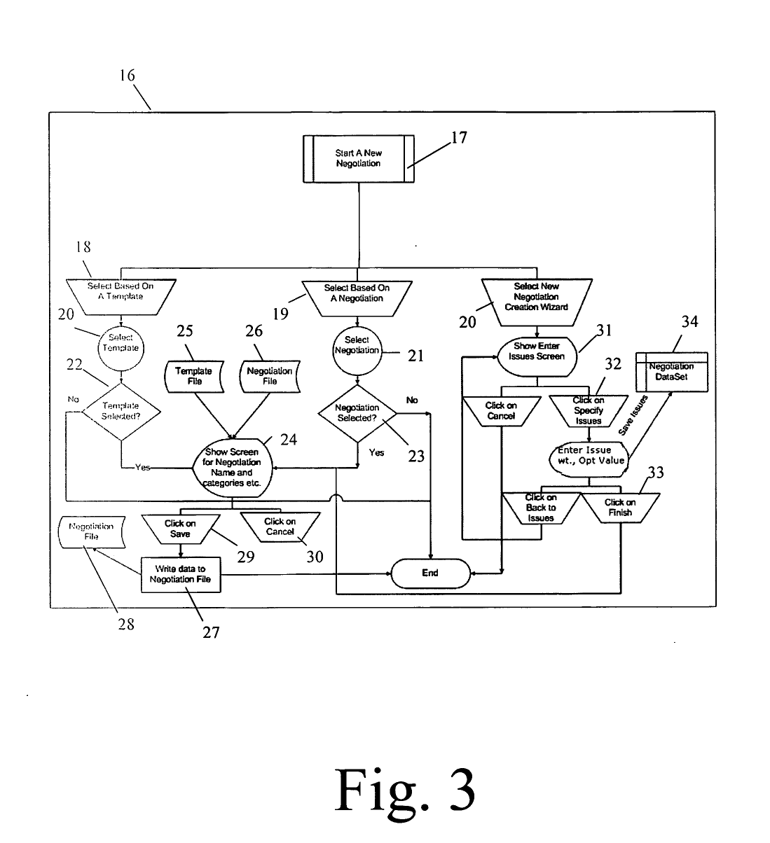

FIG. 3 shows a flow chart 16 illustrating the process steps of starting a new negotiation 17. The client user will have the option to base the new negotiation 16 on an existing template 18 or an existing negotiation 19 or start from scratch by selecting a new negotiation 20 and opening a creation wizard. If the client user selects basing the new Negotiation 17 on existing or previous Negotiation 19 or Template 18, he is shown all the available Negotiations or Templates and is allowed to select any one of those in steps 21 or 20 respectfully.

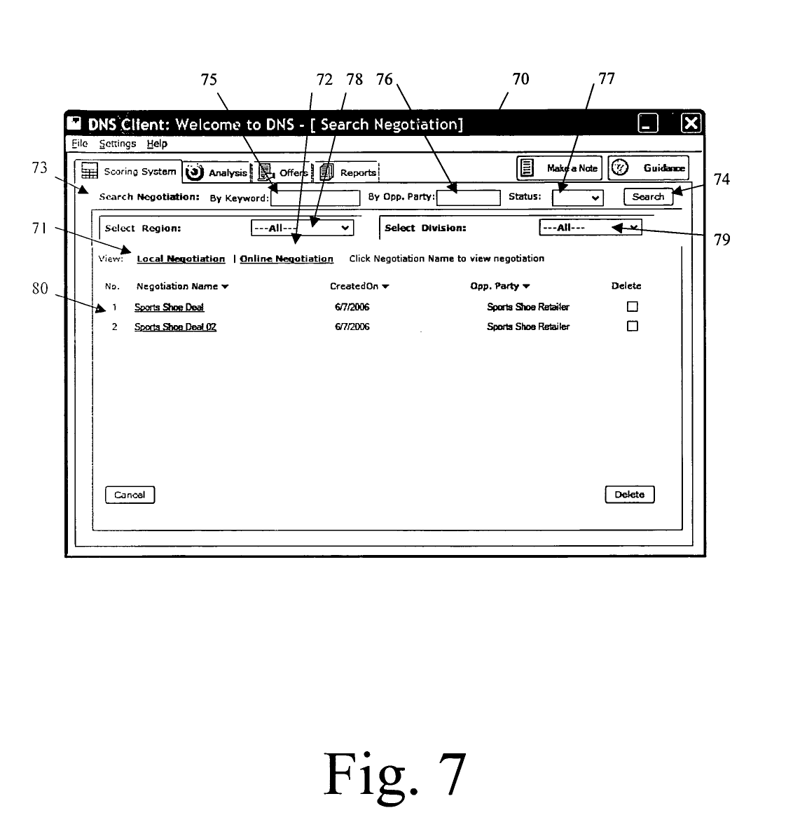

FIG. 7 shows a screen shot of the search negotiation page 70 illustrating the graphical user interface presented and the process of searching for a particular negotiation. From the search negotiation page 70, the client user can see negotiations that the client user has saved on the client user's local drive by selecting select local negotiation 71. To see all negotiations in the system stored on the online DNS web server, a user would select online negotiation 72. To search for a particular negotiation, a user would complete any of the search criteria 73 at the top of the window and select the Search button 74. The search criteria includes a keyword search 75 that requires entry of a specific keyword and results in the return of only negotiations that contain that keyword. A user can also search by the opposite party name region 78, division 79, and status tag 77. Once the search is completed and a user has located the desired negotiation, to open a negotiation in the list, the user must select the negotiation's hyper-linked name 80.

Referring back to FIG. 3, after selecting a Negotiation 23 or selecting a Template 22 on which to base the negotiation, the Main Scoring System of that Negotiation or Template is copied from either the template file 25 or negotiation file 26 in the New Negotiation Dataset, and a screen is shown 24 for entering name and categories for the new Negotiation. After all the details are filled 29 & 30, the Negotiation is written 27 in an XML file 28, and the scoring system of the new negotiation is opened.

If a client user selects to start the negotiation wizard 20, he is first asked to write and enter all the issues in the Negotiation 31. The client user must enter options 33 for each and every Issue 32 entered. After entering all the issues 32 and options 36, the client user must enter the name and categories for the new Negotiation. After all the details are filled, the Negotiation is written in an XML file containing the negotiation data set 34, and the scoring system of the new negotiation is opened.

FIG. 9 shows a screen shot of the negotiation wizard 81 illustrating the graphical representation of the software embodiment of this process. Using the Negotiation Wizard 20, the client user is stepped through creating a negotiation. The new negotiation name 82 must be entered in addition to the client user ID 89. If the client user is basing this on an existing negotiation, the original negotiation will be unaffected by the client user's changes. A description 83 is optional, but may be entered as necessary for easier review at a later time. Additionally, the other party's names 84 and client user's name must also be entered. Also, if applicable, region 85, sub-region 86, division 87, and sub-division 88 information can be entered.

At the bottom of the Start New Negotiation window 90, the client user can assign system client users 91 to the negotiation. Each client user assigned to the negotiation needs to have a role or status 92, which grants or denies rights to functionality. Available roles include: Admin: has all rights for the negotiation; Negotiator: has read and write rights; and Contributor: has the same rights as a negotiator, but is not actively involved in the negotiation; and Observer: has read-only access. Some negotiations may be viewable in the system online only by negotiators and administrators actively involved in the negotiation, but could have been viewable by contributors at one time, when they were active in the negotiation. The admin and negotiator basically have the same rights. The main difference between them is that the admin is responsible for setting up the client users, regions, departments, etc.

If the client user chooses to base the new negotiation on an existing negotiation or a template, the main scoring system is completed for the client user, as it is based on the existing negotiation or template. In this situation, skip to step 9.

### System Process

The negotiation scoring system is a series of values that define what the client user would like to achieve from the negotiation. These values include: Main scoring system; Goal; BATNA; Reservation Price; and Opposite Side Scoring as previously discussed. When the client user creates a negotiation based on an existing negotiation or a template, the scoring system is copied over from the existing negotiation or template, in which case the scoring system can be modified. When the client user creates a new negotiation using the Negotiation Wizard, the client user will have to create the scoring system.

The main scoring system is created using the Negotiation Wizard, or it is copied over from an existing negotiation or template during the negotiation creation process. Once the main scoring system has been established, the client user can return to it and make changes.

The negotiation goal is the best possible package the client user can accept. The client user can define the goal by entering a value from 1-100 manually, or the client user can pick the issue options most important to the him, the ideal package, and let the system calculate the goal value for him.

First, the client user selects a negotiation and then the Main Scoring System (MSS) of the selected negotiation is opened. A list of all the negotiations, both online and offline, is shown to the client user for selection of one. After a negotiation is selected, the system checks whether the selected negotiation is online or offline and, if online, the negotiation is first downloaded on the client's system. If the client has the appropriate permissions, the negotiation is viewable. Next, a user may either browse for a negotiation, browse for a template, or search for a negotiation. A list of all the templates, both online and offline, are shown to the client user for selection. After selecting a template, the system checks whether the selected template is online or offline. If online, the template is first downloaded on the client's system, the template is selected by the client user, and then the Main Scoring System of the selected template is opened for the client user.

Next, the client user is prompted to enter the search criteria. Afterwards, on the basis of the search criteria and the search options selected by the client user, the list of all templates matching the criteria is shown and any one of the template files can be selected.

The main scoring system shows the client user's current negotiation issues and options. The client user can add/edit weights on the negotiation grid. On the main scoring system, the client user can execute a variety of different operations, such as opposite scoring system, save, open template, search template, save as template, add issue, modify issue, delete issue, copy issue, import issues, request feedback, run indifferences tests, and create their goal, BATNA or reservation price.

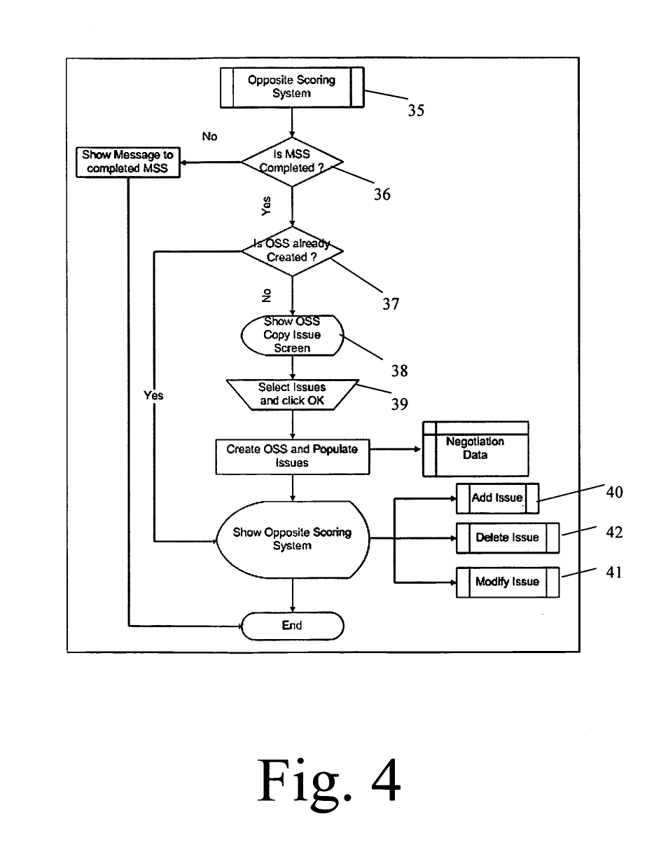

FIG. 4 shows the opposite scoring system 35 tabbed in the main scoring system screen. To create the opposite scoring system, a client user has to complete the main Scoring system 36. After that, an “Opposite Scoring System-Copy Issues” Screen 37 appears where the client user has to select the main scoring system issues 38 he wants to copy into the opposite scoring system. Selected issues are copied in the opposite scoring system tables from the main scoring system tables in an internal dataset and populate 39 the opposite scoring system issues on screen.

The client user can add issues 40 on the Main Scoring system, the Opposite Scoring System, and BATNA. The client user simply has to enter a new issue name, issue weighting, insert at position, option under this issue and their corresponding values.

The client user can modify issues 41 of Main Scoring system, Opposite Scoring System, and BATNA. Additionally, the client user can delete issues 42 from the Main Scoring system, Opposite Scoring System, and BATNA. On the delete screen there is a listing of all the issues; a client user simply has to check the issues they want to delete then select “Delete.”

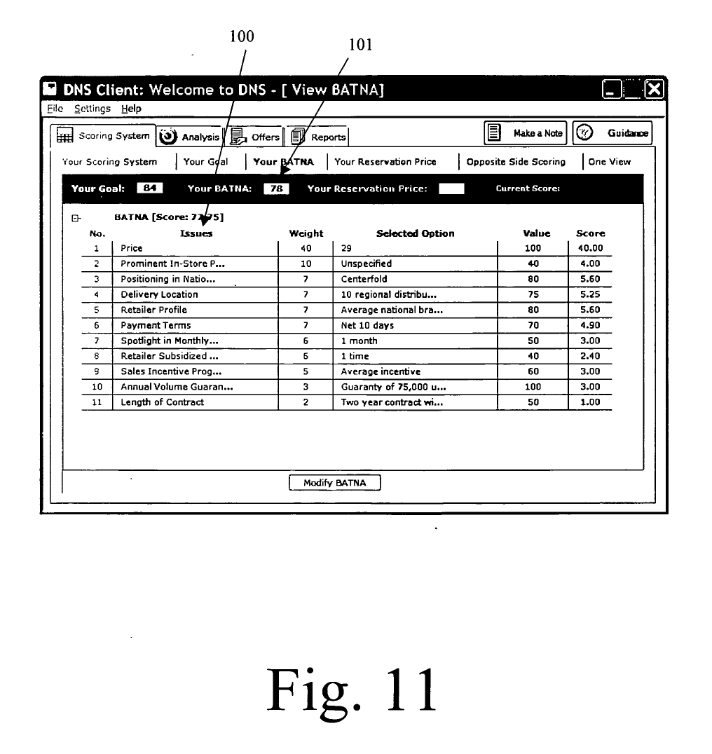

The BATNA is the client user's Best Alternative To a Negotiated Agreement and is the client user's best competitive deal. BATNA usually involves settlement with another party and it could have a different set of issues. Referring to FIG. 11, the client user can define BATNA by entering a value from 1-100 manually 101 or the client user can pick the issue options 100 for BATNA (the BATNA package) and let the system calculate the BATNA value 101 for the client user.

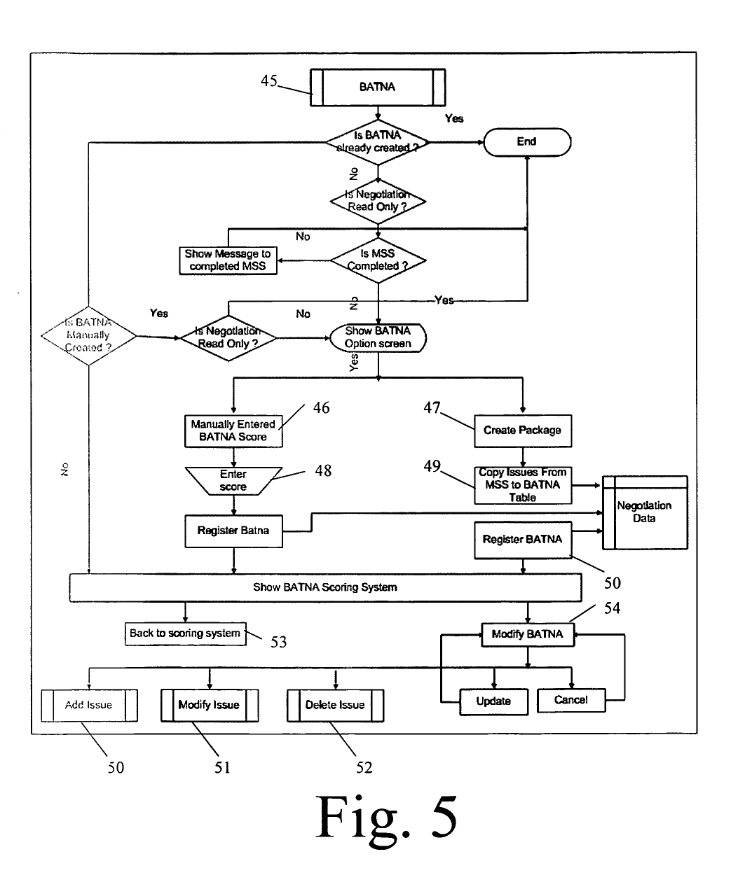

As illustrated in FIG. 5, to register BATNA 45, a client user has to complete the Main Scoring system. After that, there are two options to register BATNA: Manually entering the BATNA score 46, and creating a package 47. In the first case, only the BATNA score 48 is saved in the BATNA table, while in the other case, all the Main Scoring system issues are copied in BATNA tables 49 after registration 50. After Registration, a client user can complete different operations on BATNA Packages like: Add Issue 50, Modify Issue 51, Delete Issue 52, Return to the scoring System 53, and Modify BATNA 54.

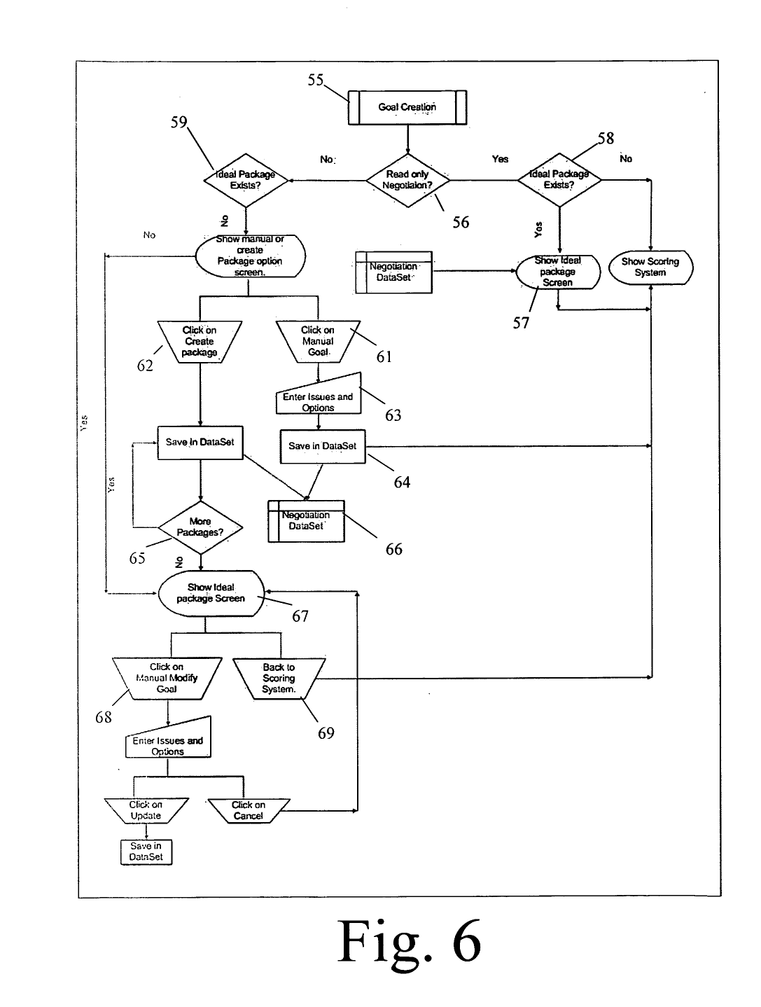

Now focusing on Goal Creation 55 as illustrated in the flow chart of FIG. 6, the system first checks to see if the Negotiation is read only 56, making the user or person an observer. If it is, the client user can only view already created ideal packages for the goal 57 if they exist 58. Otherwise, the client user is given the option of creating his goal 60, if packages do not already exist 59, by manually entering a goal value 61 or creating ideal packages 62 for registering the goal value. If the manual creation of goal 61 is chosen, the client user is prompted for a goal value 63, which is registered as the goal and saved 64 in the Dataset 66. Otherwise, the client user is given the option of creating one to five goal packages 65 depending upon the value set up in the system's Advanced Options. When all the packages are created, the client user is shown those packages 67 and given the option of modifying 68 these packages or returning to the scoring system 69.

The Reservation Price (RP) is the client user's bottom line and is the least preferred but still acceptable package. The client user can define reservation price by entering a value from 1-100 manually, or the client user can pick the issue options to make up the client user's bottom line (the RP package) and let they system calculate the reservation price value for the client user.

To define an RP package, the client user must select one option for each issue so that the client user ends up with a package of issue options that the client user can least accept. If the client user wants to add another RP package, he could create another RP package and, again, select a combination of bottom-line issue options and continue to add RP packages as necessary. When the client user is finished, the RP packages are saved and listed and the client user's Reservation Price at the top of the window is automatically calculated as a weighted average score of the defined RP packages.

Reservation price follows the same process steps and flow as goal creation. The system checks if the Negotiation is read only and, if it is, then the client user can view only already created packages for reservation price. Otherwise, he is given the option of creating the reservation price if packages do not already exist by manually entering a reservation price value or creating packages for registering the reservation price value. If the client user chooses the manual creation of reservation price, he is prompted for a reservation price value, which is registered as reservation price in the Dataset. Otherwise, he is given the option of creating one to five packages, depending upon the value set up in the system's Advanced Options. When all of the packages are created, the client user is shown those packages, and he is given the option of modifying these Packages.

The client user can enter and save the weaknesses of the other side in a Negotiation. If the Negotiation has been opened in Read Only mode, the client user can view only the already created Weaknesses. Otherwise, the client user can add, edit, and view the other side weaknesses.

To upload the file, the system will check whether the client user is logged in. If not, it will ask for login. After the client user is logged in, all of the negotiation data is copied from local storage to the system's online tables through a web service. A confirmation message will be displayed on successful upload of data.

Feedback includes comments from others regarding the negotiation. Feedback helps the client user refine the client user's negotiation. For example, feedback from others might bring up issues the client user forgot, or it may help the client user refine weightings. A client user assigns weight values to the feedback of other client users based on their importance. For example, feedback from someone with knowledge about the inner workings of the business is much more valuable to the client user than feedback from someone without that knowledge. Client users can also select whether to send only the negotiation issues to the selected client users or to include the issue options as well.

With respect to Weighing Feedback, the system of the present invention will check whether the client user is logged in. If not, it will ask for login. After that, the system will check whether the current negotiation is uploaded. If a file is already uploaded, the system sends a request to the online web server for a list of client users that are assigned for this negotiation. After the system gets the client user list, it is populated on screen. Client users have to select different client users and enter the number of days for current Session of feedback. On selecting “Send Feedback,” the system creates a new session and copies related data on the system's web server and provides confirmation.

To reconcile feedback, the system checks whether any session exists that is not expired. If a session is found, the system will copy related data from the system's online database to the current Negotiation file via the web service and provide confirmation.

When a client user selects weighing feedback, the system shows all the existing feedback sessions by reading it from internal data storage. A client user has to select one session that is already reconciled. After selecting the session, the system reads the data from the negotiation file and populates the screen.

To create Multiple Equivalent Simultaneous Offers (MESO), a client user has to complete the MSS. Then an “Ask MESO Score” screen appears, into which the client user has to enter the MESO set name and score on which he wants to create the MESO offer. After entering the MESO score, the system will calculate the minimum offers. Minimum offers are read from the client security. All of the generated offers are populated and saved in MESO tables.

When a client user selects Goal, the system checks whether the Goal is registered. If the Goal is registered, the system shows the MESO Set at Goal by reading it from the MESO tables. Otherwise, it shows message to create goal.

When a client user selects MESO at Reservation Price from a main menu, the system checks whether the Reservation Price is registered. If the Reservation Price is registered, the system simply shows the MESO Set at Reservation Price by reading it from the MESO tables. Otherwise, it shows message to create Reservation Price.

Indifference testing creates packages at a certain score to help the client user decide if he is truly indifferent between these packages. To create Indifferent tests, the client user has to complete the Multiple scoring system. After that, an “Ask Indifference Test Score” screen appears, where the client user has to enter the Indifference Test score on which he would like to view Indifference packages. After entering Indifference Test scores, the system will calculate the closest minimum offers. Minimum offers are read from the system's client security. All the generated offers are populated and saved in Indifference Test tables and can be compared side-by-side using OneView.

A client user can run an Indifference Test repeatedly by entering a new Score. A client users can create his goal from here and also modify the existing packages. In OneView (or in the standard view), a client user can change issue weights and option values directly on the screen according to his judgment and run the indifference test repeatedly to tweak the values of the packages until he is satisfied.

When the client user selects the close menu item, he is asked if he wants to save any changes made in the Negotiation in the file. If the client user selects save, all of the changes in the dataset are accepted, and the Negotiation file currently opened is updated. Afterwards, the Negotiation is closed and cleared from memory. If the client user chooses not to save, the File is not updated and all the changes are lost when the Negotiation is closed and cleared from memory.

When the client user selects the close menu item, he is asked if he wants to save any changes made in the Template in the file if he was working on a template. If he selects save, all of the changes in the dataset are accepted and the Template file currently opened is updated. Afterwards, the Template is closed, i.e. cleared from memory. If the client user chooses not to save, the File is not updated and all of the changes are lost when the Template is closed, i.e. cleared from memory.

The Offer Repository shows a list of all the MESO sets that are generated by the current negotiation. By default, recent MESO sets are shown, and the client user can select another MESO set to view its offers. If no MESO set exists, a message is displayed that states “No Offer Repository exists.”

When the client user selects the save menu item, all of the changes in the dataset are accepted, and the Negotiation file currently opened is updated. Afterwards, a message is displayed to the client user informing him that the file has been updated.

When the client user selects the save menu item, all of the changes in the dataset are accepted, and the Template file currently opened is updated. Afterwards, a message is displayed to the client user informing him that the File has been updated.

When the client user wishes to check entered offers history, he's shown the offers in a tab control where he can view different offers previously entered by selecting different tab pages.

The client user can view and edit the system's advanced options, such as number of Ideal packages for goal creation and number of reservation price packages. All of the data is taken from Windows Registry, where it is stored and shown to the client user. After the client user has made changes and the changes have been validated according to the constraints, the changes are saved back in the Registry entries.

The client user is given the option of changing his login name and/or password and whether a login is required every time the application is opened. This information is stored in the Windows Registry from where it is shown in the form, in which the client user can make the modifications and save the changes back in the registry.

The client user can save a currently opened Negotiation as template. The Main Scoring System of the Negotiation is copied in a temporary Dataset and the client user is prompted to give details such as name and categories for the Template before saving it. When the details are provided, the Data is written into a Template File and a message is shown to the client user that the Template has been created.

When the client user selects to copy issues in the Negotiation from a template, he is shown the list of Templates both online and offline, from where he can select the source of issues to be added to the Negotiation. After a file is selected, the list of all issues available in that file is shown from where the client user can select the issues to copy. Afterwards, the selected issues along with their options and weightings are copied into the Main Scoring System of the Negotiation currently open.

Negotiation templates contain preset information about a business. When they are used to start a negotiation, most of the information will be completed automatically. They enforce consistency and standards throughout an organization or division. In the system of the present invention, the client user can use templates to create a negotiation and save negotiations as templates.

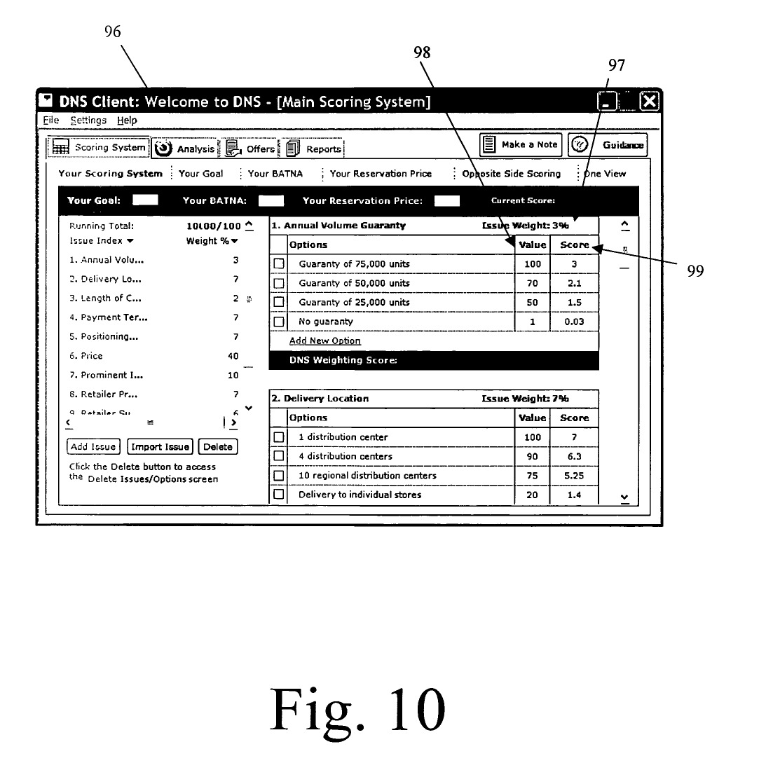

When the client user selects to copy issues in the Negotiation from an existing or previous Negotiation, he is shown the list of Negotiations, both online and offline, from where he can select the source of issues to be added to the Negotiation. After a file is selected, the list of all issues available in that file is shown from where the client user can select the issues to copy. Afterwards, the selected issues along with their options and weightings are copied into the Main Scoring System of the Negotiation currently open. FIG. 10 illustrates the negotiation scoring system displays 96, showing the resulting issue scoring 99 based on the issue weights 97 and option values 98.

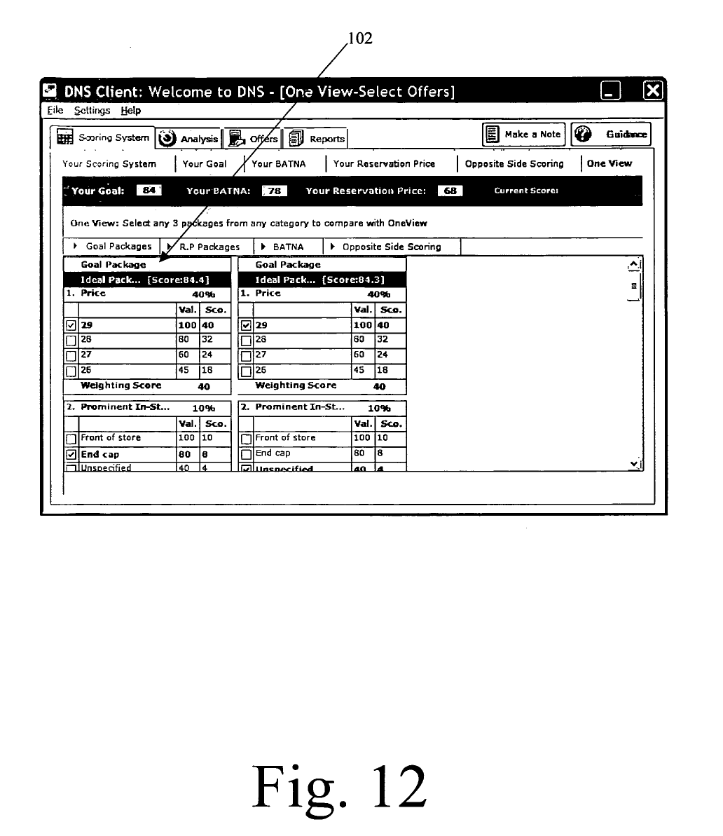

Now referring to FIG. 12, OneView lets the client user compare goal packages 102, BATNA, RP packages, and opposite side scoring by placing selected information on the same window. A client user can select the type of scoring values he wants to compare. For example, if the client user wants to compare goal packages, he would select Goal Packages.

Once the client user has completed his scoring system, he can test it using the system's analysis features. To test his scoring, the client user can use: Indifference testing, which displays packages at a specific score, letting the client user test the client user's own tolerance to them; Feedback to get the opinions of other involved in the negotiation; Conjoint analysis, which asks questions to test the integrity of weightings; and Other side weaknesses, which lets the client user capture and record weaknesses of the opposite party. The client user can also input ideas on how these weaknesses can be used to his advantage.

Conjoint analysis asks the client user difficult “tradeoff” questions regarding the negotiation and its scoring system. The answers are used to compute the relative value an individual truly places on certain issues and options. This creates an aggregate weighting system much more precise than the somewhat arbitrary weighting system which may otherwise be created.

A weakness list defines points of weakness that can help the client user's side during negotiation. The weakness list includes the other side's weaknesses in one column and whether the client user can elaborate on how the weakness can be used to his advantage during negotiation in the right column. Additionally, the client user can select View Opp. Side Scoring to see what was listed as the issues thought to be most important to the other side.

Once the client user has analyzed his scoring system, he is ready to generate a set of acceptable offers, or Multiple Equivalent Simultaneous Offers (MESOs), and extend offers to the other side. The steps to process offers, from creation to presentation are: Create MESO sets; Compare MESO sets; Filter MESO sets; Make offers to the other side; and Compare offers from both sides.

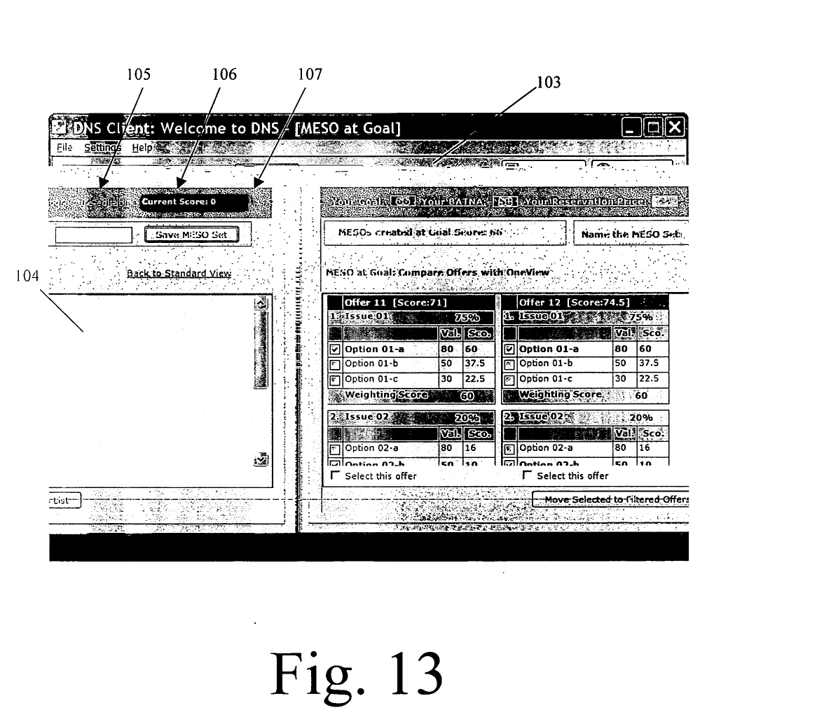

Now referring to FIG. 13, OneView 103 is utilized to compare the packages 104 the client user has created for MESO sets. The object is to identify the most appealing packages to determine which packages the client user wants to truly include in the MESO sets and offer. There is a check box above each package on the MESO at Goal 105, MESO at RP 106, and Create MESO tabs 107. The client user checks the packages he wants to compare. The client user can check up to three per scoring type. Then, the client user selects Compare Offers using OneView and OneView appears with the selected packages 104 displayed side-by-side.

During the second step of the offer management process, the client user filters out packages within MESO sets that he thought might be viable for offering. This step lets the client user review the filtered packages and select the final packages for offering. When the client user opts to filter the selected packages, the Filtered Offers window 108 appears. The Filtered Offers window 108 lists the offers 109 the client user has selected. Note that the client user can change the Open Existing MESO Set setting to see a different MESO set as desired. Next, the client user would select the packages he wants to offer to the other side and select Export Selected to ‘Make an Offer’ 110 and the Make an Offer window appears.

During the third step of the offer management process, the client user selects packages from MESO sets to offer to the other side. This step makes those packages official offers. When the client user selects Export Selected to ‘Make an Offer’ 110 on the Filtered Offers window 108, the Make an Offer window appears. Finally, the client user selects the packages 109 he wants to extend as official offers and an Offers Made window appears.

During the fourth step the client user compares offers from both sides 111 & 112.

### Reporting

Negotiation Reports provide formatted and streamlined information. All reports appear in .pdf format in Acrobat Reader or an equivalent document viewer. In a preferred embodiment, the following reports are included: MESO report; Executive Summary; Offer History report; Summary report; and Negotiation Notes report.

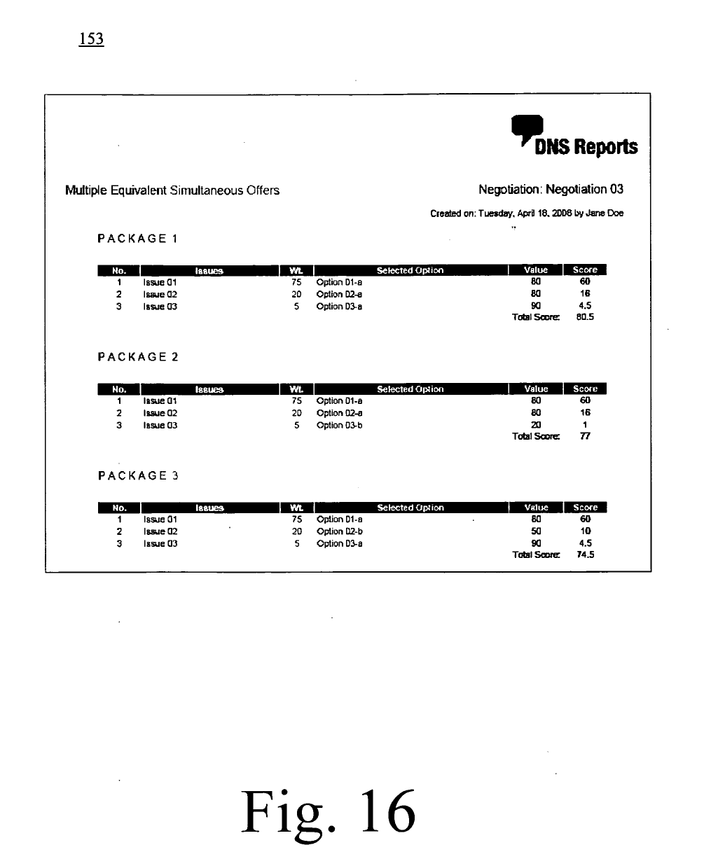

The MESO report lists packages with the same selected score plus or minus a few points. For example, if the client user selected to see all negotiation packages with a score of 80, the MESO report might list all packages scored 77-83. There are two versions of the MESO report available: one with scoring 153 and one without. The report is available without scoring to provide more confidentiality if it needs to be taken into the negotiation room. An example of the MESO report with scoring 153 is illustrated in FIG. 16.

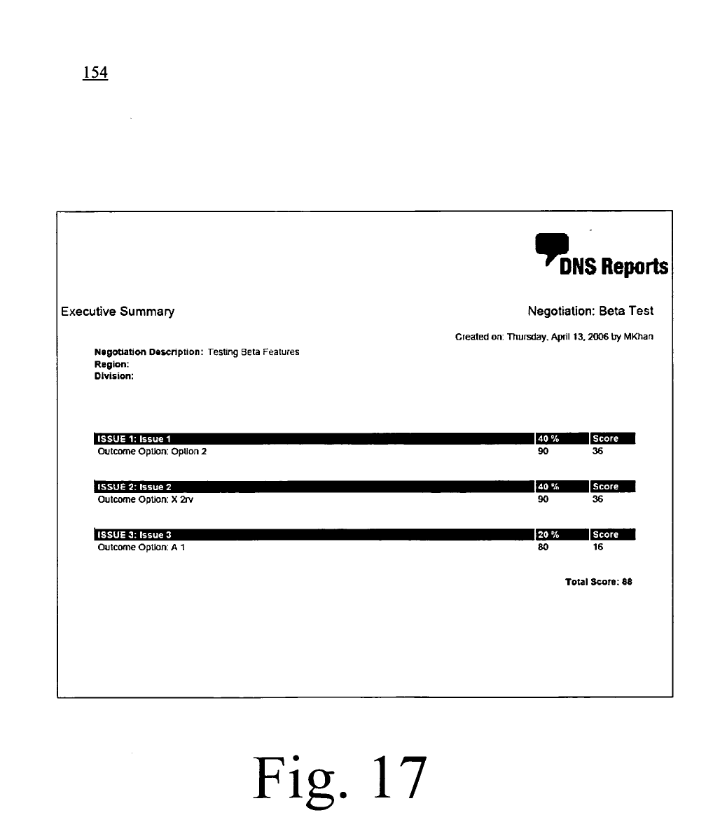

Executive Summary report outlines the terms of the agreement. There are two versions of the Executive Summary available: one with scoring and one without. The report is available without scoring to provide more confidentiality if it needs to be taken into the negotiation room. An example of the Executive Summary with scoring 154 is illustrated in FIG. 17.

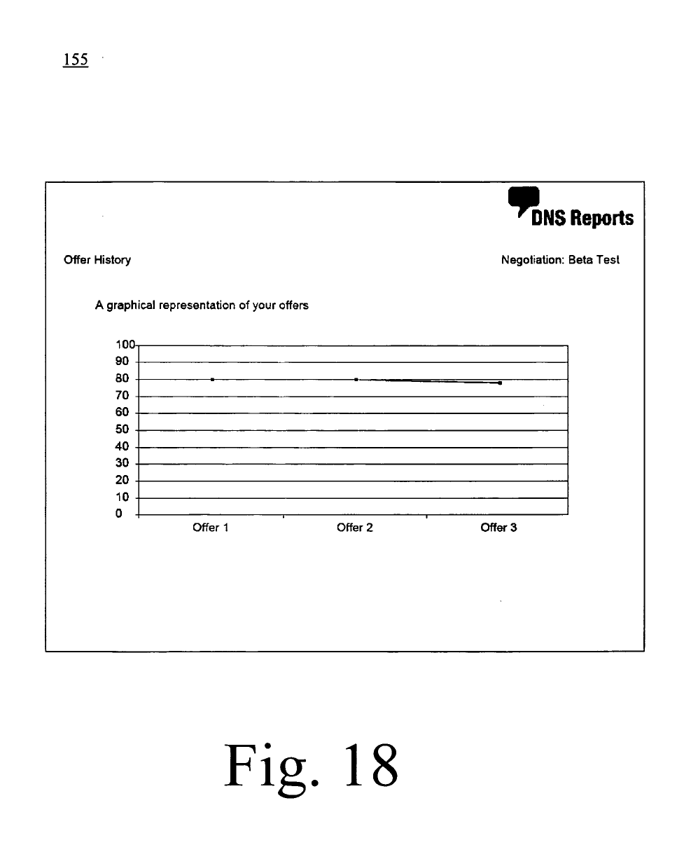

The Offer History report provides a graphical representation of the offers that the client user has made to the other side. An example of the Offer History report is illustrated in FIG. 18. The Summary report is a combination of the Executive Summary report and the Offer History report 155.

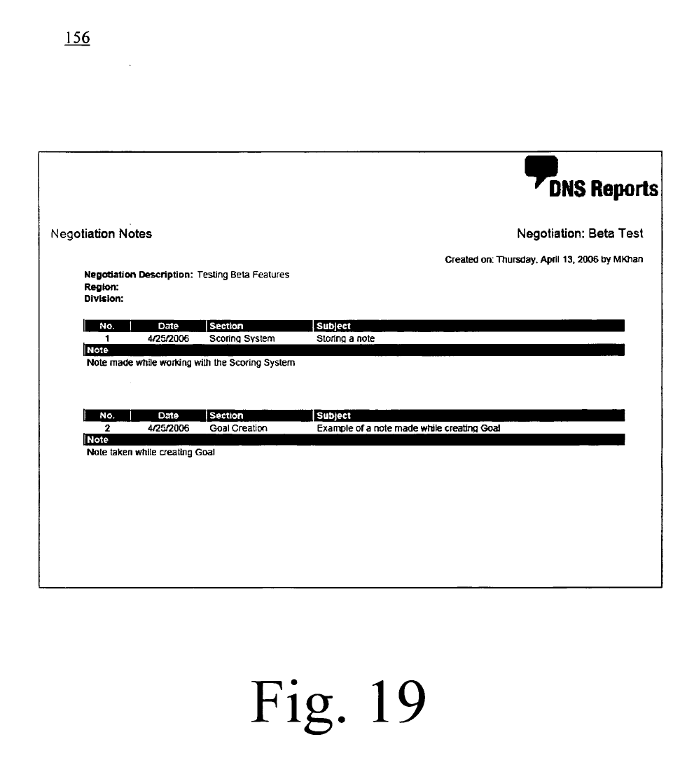

The Negotiation Notes report 159 lists any notes that have been added to the negotiation. An example of the Negotiation Notes report 159 is illustrated in FIG. 19. Negotiation notes 159 are comments for a specific section within a specific negotiation. For example, the client user may want to note in the Scoring System section that the salary for the client user's union employees is higher than any other union in the Midwest. In the system, the client user can: View negotiation notes; Add negotiation notes; Edit negotiation notes; and Delete negotiation notes.

Finally, if the client user wants to share reports, the client user needs to upload them. Uploading reports makes them available through the system Online, where other client users can access them.

### Implementation of Conjoint Analysis

Conjoint analysis is one of the terms used to describe a broad range of techniques for estimating the value people place on the attributes or features that define products and services. Within the context of Dynamic Negotiation System (also referred to as “DNS”), it is the value a negotiator places on the Issues and a range of alternative Options for that particular issue.

The goal of DNS conjoint survey is to assign specific weights and values to the range of Issues and Options negotiators consider when making a decision. These weights or ratings, when taken together, allow the negotiator to value the relative importance of each of the Issues studied. Instead of “stated importance,” conjoint analysis uses “derived importance” values for each issue or option. Armed with this knowledge, negotiators can focus on the most important Issues and Options that increase the overall value of the negotiation.

The DNS Conjoint Analysis module is a unique technique for handling situations in which a decision maker has to deal with options that simultaneously vary across two or more issues. The problem the decision maker faces is how to trade off the possibility that option X is better than option Y on issue A while W is better than Z on issue B, and various extensions of these conflicts.

As an example to understand the concepts of DNS conjoint analysis, assume that a VP of Logistics and Trade at a national retailer is examining Trade Finance offerings from several national and global banks. This process may force the VP to visit many banks and create several negotiation packages.

One of the first steps in designing a successful negotiation is to develop a set of issues and corresponding issue-options to characterize and weigh these issues in relative importance. Focus groups, in-depth interviews, and internal corporate expertise are some of the sources users of DNS use to structure the sets of issues and options that guide the rest of the negotiation.

DNS helps the negotiator in the process of capturing all relevant issues and options and their relative weights and values by providing an intuitive facility comprising of a set of screens that guide the user through the process. This facility is invoked when the negotiator chooses the use of the Wizard on the Workspace screen to start a new negotiation. The results of the process are presented in Table 1.

TABLE 1
Issues and Option in a negotiation

| Issue (Weight) | Option (Values) | | |
|---|---|---|---|
| Presence (25) | International | National (90) | Local (80) |
| | (100) | | |
| Portal Usage Fees (15) | Free (90) | Per User (80) | |
| Back Office ERP | Yes (100) | No (50) | |
| Integration (12) | | | |
| Access Security (12) | Dual Factor | Certificate | Static User/Pwd |
| | (90) | Based (80) | (40) |
| Traditional Products | Yes (90) | No (1) | |
| (12) | | | |
| Supply Chain Products | Yes (90) | No (1) | |
| (12) | | | |
| Supply Chain Finance | Yes (100) | No (60) | Just PO |
| (12) | | | Drawdown (40) |

After all relevant issues and options and their corresponding weights and values have been captured, the negotiator can run a Conjoint Survey. Table 2 describes how an instance of a conjoint survey is created on the DNS Online Service of the present invention.

TABLE 2
Steps to create a conjoint survey in DNS

| Step | Negotiator | DNS |
|---|---|---|
| 1. | Negotiator invokes the facility to | Process instantiated |
| | create Conjoint Analysis Survey | |
| 2. | Selects from a list of users a | Selected list of contributors |
| | group of contributors to sent invite | stored |
| | to participate in the survey | |
| 3. | Confirms to create survey and | Creates a secure space for |
| | send invite | Conjoint Analysis survey and |
| | | sends an email with a URI to |
| | | Contributors inviting them to |
| | | take part in the survey. |
| 4. | | Creates actual survey and |
| | | presents it as contributors log |
| | | in |

DNS allows the negotiator to select which issues to send to conjoint analysis. Based on feedback from previous analytical exercise, DNS may “auto-suggest” which issues to send to conjoint analysis. For such negotiation, DNS prepares several Negotiation Packages. An algorithm is derived to randomly select issue options from the list of issues and ask questions.

In a small conjoint survey (similar to the one presented above with six or seven issues, each with two or three options), as contributors begin their survey, they are presented with full profile packages—anywhere between sixteen and thirty-two. In this case, contributors typically rate the packages on a zero to one hundred likelihood of a deal scale.

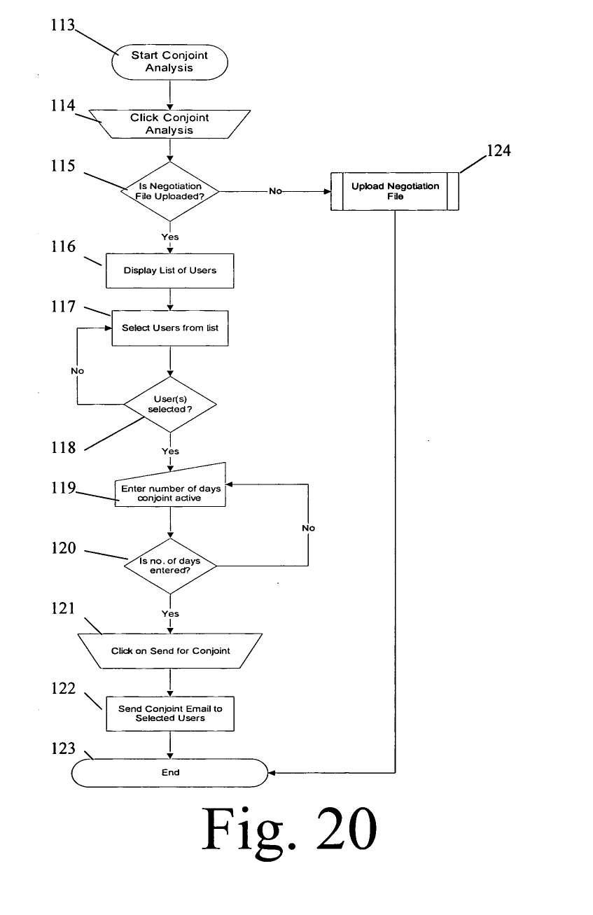

FIG. 20 illustrates the Send for Conjoint Analysis process. To Send for Conjoint, the system will check whether the user is logged in; if not, it will ask for login. After login, the conjoint analysis is started 113 and a user selects conjoint analysis 114. The system will check whether a current negotiation is uploaded 115. If a file is already uploaded, the system requests to DNS online for a list of users that are assigned for this negotiation 1 16. After getting a user list 116, it will populate the user list on screen. A user next has to select different users 118 from a user list 117 and enter days 120 to live Conjoint Analysis 119. On clicking “Send for Conjoint” 121 the system creates a session and copies related data on the DNS Online via web service. A confirmation message will be displayed upon successfully sending for Conjoint Analysis, an email is sent to selected users 122, and the process ends 123.

After some contributors have taken the conjoint survey, the negotiator can download the respondent data and weightings from the online system and compare them against each other. The system will aid the negotiator by automatically computing a weighted average for each issue and option. The result can then be reconciled against the negotiators scoring system.

DNS allows the user to set the feedback and weightings at the individual user level. For example, a Senior Corporate Director's feedback may be weighted more heavily than a Junior Analyst. By soliciting feedback from key stakeholders the negotiator gains a thorough understanding of how team members truly weight particular tradeoffs.

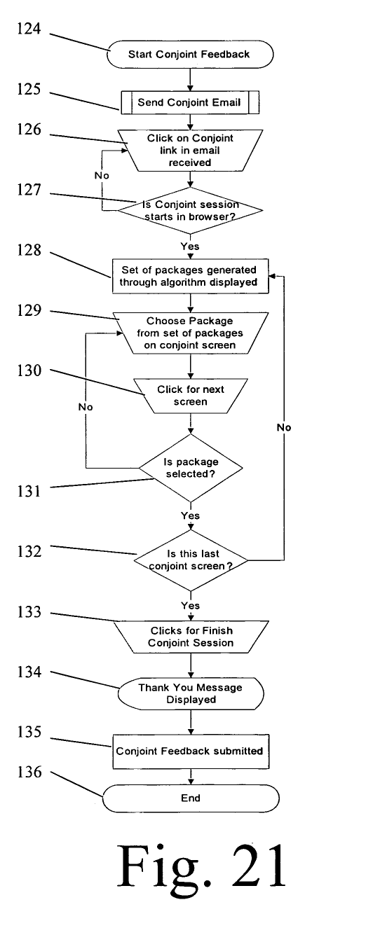

FIG. 21 illustates the process for submitting conjoint feedback. To Submit Conjoint Feedback 124, DNS first sends the user a conjoint email 125. The user then has to click the link received in his conjoint survey email 126 and open a conjoint survey session in a web browser 127. Once the session is started 127, a set of packages is generated through an algorithm and displayed to the user 128. Next, the user chooses a package from a set of packages on the conjoint screen 129 and continues through a plurality of screens 130 until a package is selected 131. After a package is selected 131, the user finishes the conjoint session 133 when the last screen 132 is reached. A system message appears 134, the feedback 135 is submitted, and the process ends 136.

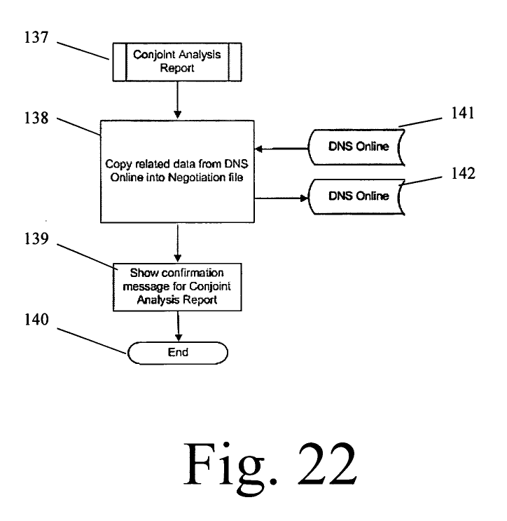

Now referring to FIG. 22, to receive a Conjoint Analysis Report 137, the System will copy related data from DNS Online 141 to the current Negotiation file 138 via a web service to DNS Online 142. A confirmation message is displayed on successful Conjoint Analysis Report generation 139 and the process ends 140.

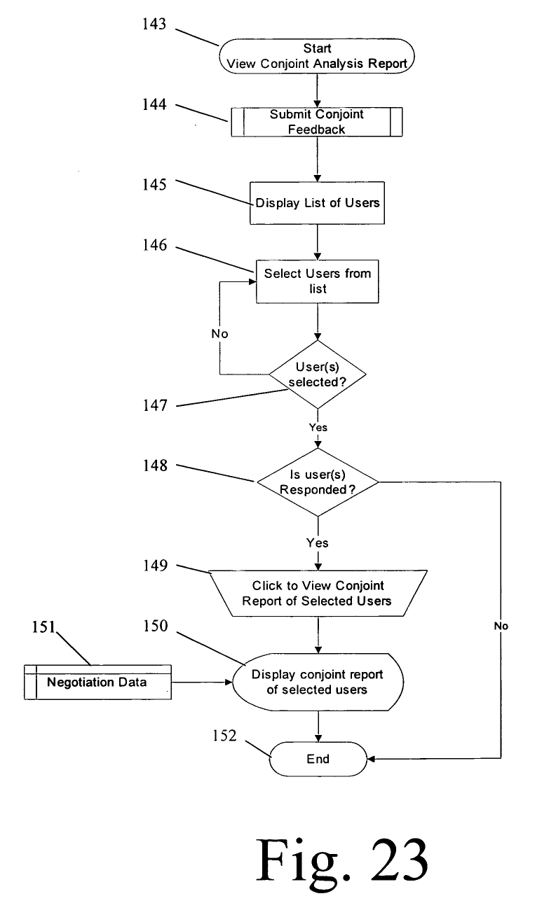

Now referring to FIG. 23, when the client user clicks on View an Analysis Report to start 143, the system requires conjoint feedback to be submitted 144, then displays a list of conjoint survey respondent users 145 and populates the conjoint survey respondent users list 146 and the respective status about the response (conjoint analysis) on screen. The client user has to select one or all conjoint survey respondent users 147 to determine if the conjoint survey respondent users has responded 148 to view the Issues weight and Option values after Conjoint Analysis of the users 149. The system will read the data from Negotiation file 151 and populate on screen to display the conjoint report of selected conjoint survey respondent users 150, then the process ends 152.

It is appreciated that the optimum dimensional relationships for the parts of the invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method, and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A Method for Preparing for a Negotiation consisting of:
listing and ranking issues;
creating a list options for each issue and ranking them individually, whereby each issue is ranked manually or through conjoin analysis;
defining a goal;
defining a BATNA;
determining a reservation price; and
considering the weakness of the other parties involved in the negotiation to predict the other parties' reactions to proposed options.

2. The Method for Preparing for a Negotiation of claim 1 further comprising the step of fractionating the issues into a plurality of sub-issues and assigned a weighted percentage according to the importance the issue carries in the negotiation.

3. The Method for Preparing for a Negotiation of claim 2 wherein the total of the weighted percentage equals any desired percentage.

4. The Method for Preparing for a Negotiation of claim 1 further comprising the step of scoring and comparing current alternative actions to the BATNA.

5. The Method for Preparing for a Negotiation of claim 1 further comprising the step of listing options for each issue and ranking them individually.

6. The Method for Preparing for a Negotiation of claim 1 further comprising the step of defining a goal that reflects a desired outcome from the negotiation.

7. The Method for Preparing for a Negotiation of claim 1 wherein
the users BATNA must be determined;
the user's BATNA is the users best outside alternative;
the BATNA does not look the same as the current deal and cannot be compared on a single issue; and
the scoring allows evaluation of the BATNA across a full range of issues.

8. The Method for Preparing for a Negotiation of claim 1 further comprising the steps of:
establishing a minimum condition to which will be agree upon with the other party in the negotiation;
setting a reservation price as the bottom line price;
defining the reservation price across a plurality of issues;
equating the reservation price to the BATNA plus or minus any idiosyncratic factors that might make one alternative preferred over another; and
calculating the BATNA, which value determines the value of the reservation price.

9. The Method for Preparing for a Negotiation of claim 1 further comprising the steps of:
considering the weaknesses of the other parties involved in the negotiation;
choosing and weighing issues and issue options that are assumed important to the other side; and
predicting the other side's reactions.

10. The Method for Preparing for a Negotiation of claim 1 further comprising the steps of:
providing a negotiation software system on a central web server connected via a multi-client user network to the Internet connected to one or more client computers;
said client computers communicate with the central web server for licensing purposes, as well as automating negotiation between users so they can complete deals amongst themselves; and
providing a client application that is loaded on a client computer and is accessed by a client user client.

11. The Method for Preparing for a Negotiation of claim 10 further comprising the steps of:
selecting a negotiation and opening a Main Scoring System for the selected negotiation;
listing all the negotiations both online and offline and presenting them for selection;
checking whether the selected negotiation is online or offline;
if online, downloading the negotiation;
listing all templates both online and offline for selection;
checking whether the selected template is online or offline;
if online, downloading the template and opening the main scoring system of the selected template;
entering template search criteria and listing all templates matching the criteria;
showing current negotiation issues and their options on the main scoring system;
adding or editing weight on a negotiation grid; and
deleting, adding, or updating issues on the main scoring system, an opposite scoring system, and BATNA.

12. The Method for Preparing for a Negotiation of claim 11 further comprising the steps of:
defining the BATNA by entering a value; or
selecting issue options for the BATNA and calculating the BATNA value for the user.

13. A Method for Preparing for a Negotiation of claim 11 further comprising the steps of:
checking if the Negotiation is read only;
if the Negotiation is read only, providing read only already created ideal packages for the goal if they exist;
if the Negotiation is not read only, creating a goal if packages do not already exist by manually entering a goal value or creating ideal packages for registering the goal value;
if the manual creation of goal is chosen, manually entering a goal value, which is registered as the goal and saved in a dataset;
creating one or more goal packages; and
viewing goal packages; and
modifying goal packages and returning to the scoring system.

14. A Method for Preparing for a Negotiation of claim 11 further consisting of a Reservation Price, which is user's least preferred but still acceptable package, comprising the steps of;
defining one or more reservation prices by entering a value manually or calculating the reservation price values;
to define a reservation package, selecting one option for each issue creating a package of issue options that can be least accepted; and
saving the reservation package packages and listing the Reservation Price automatically calculated as a weighted average score of the defined reservation package packages.

15. A Method for Preparing for a Negotiation of claim 11 further comprising the step of entering and saving the weaknesses of other side in a Negotiation.

16. A Method for Preparing for a Negotiation of claim 11 further comprising the step of providing feedback comments regarding the negotiation.

17. A Method for Preparing for a Negotiation of claim 11 further comprising Multiple Equivalent Simultaneous Offer generation comprising the steps of:
completing the Scoring System;
entering the MESO set name and score to create the MESO offer;
after entering the MESO score, calculating the minimum offers;
reading minimum offers from a client security and generating offers to be saved in MESO tables;
selecting a Goal, checking whether the Goal is registered or not and if the Goal is registered, the showing the MESO Set at Goal; and
selecting MESO at Reservation Price, checking whether the Reservation Price is registered or not and if the Reservation Price is registered, then the system shows the MESO Set at Reservation Price.

18. A Method for Preparing for a Negotiation of claim 11 further comprising indifference testing comprising the steps of:
creating packages at a certain score to help the user decide if the client user is indifferent between them;
checking the validity of thee scoring system; and
testing two or more real examples for indifference between them.

19. A Method for Preparing for a Negotiation of claim 1 further comprising a conjoint comprising the steps of:
answering tradeoff questions regarding the negotiation and its scoring system; and
computing the relative value an individual truly places on certain issues and options and creating an aggregate weighting system.

20. A Method for Preparing for a Negotiation of claim 18 wherein once the scoring system has been analyzed, generation of a set of acceptable offers, or Multiple Equivalent Simultaneous Offers, and extend offers to the other side can be made, comprising the steps of:
A. creating MESO sets by:
creates MESOs as the goal the client user has established in the client user's scoring system;
creates MESOs at the reservation price the client user have established in the client user's scoring system; and
creates MESOs at the value the client user enters;
B. comparing MESO sets;
C. filtering MESO sets;
D. making offers to the other side; and
E. comparing offers from both sides.

21. A Method for Preparing for a Negotiation of claim 20 further comprising conjoint analysis assigning specific weights and values to the range of Issues and Options; said weights and values, when taken together, provide means for the user to value the relative importance of each of the Issues studied providing derived importance values for each issue or option.

22. A Method for Preparing for a Negotiation of claim 21 further comprising the steps of:
selecting which issues to send to conjoint analysis;
based on feedback from previous analytical exercise, suggesting which issues to send to conjoint analysis; and
preparing several Negotiation Packages using an algorithm derived to intelligently select issue options from the list of issues and ask questions to obtain the optimal conjoint survey results.

23. A Method for Preparing for a Negotiation of claim 22 wherein to Send for Conjoint further comprising the steps of:
checking whether current negotiation is uploaded;
requesting the central server for a list of users that are assign for this negotiation;
requiring a user to select different users from a user list and enter days to live;
creating a session and copies related data on the central web server;
after all contributors have taken the conjoint survey, downloading the respondent data and weightings from the online system and comparing them against each other; and
aiding the negotiator by automatically computing a weighted average for each issue and option so the results can then be reconciled against the negotiators scoring system.

24. A Method for Preparing for a Negotiation of claim 23 comprising the following additional steps to Submit Conjoint Feedback:
sending the user a conjoint communication;
requiring a user to open a conjoint session;
generating a set of packages through an algorithm and displayed to the user;
continuing through a plurality of screens, each with one package, until the set of packages is completed; and
finishing the conjoint session and submitting feedback.
